(19) United States
(12) Patent Application Publication
(10) Pub. No.: US 2011/0088381 A1
(43) Pub. Date: Apr. 21, 2011

(54) DRIVE TRAIN WITH A HYDRODYNAMIC MACHINE ARRANGED ON THE OUTPUT SIDE OF THE TRANSMISSION

(75) Inventors: Klaus Vogelsang, Crailsheim (DE); Peter Heilinger, Satteldorf (DE)

(73) Assignee: VOITH PATENT GMBH, Heidenheim (DE)

(21) Appl. No.: 12/735,107

(22) PCT Filed: Jan. 22, 2010
(86) PCT No.: PCT/EP2010/000362

§ 371 Date: Dec. 29, 2010

(30) Foreign Application Priority Data
Mar. 12, 2009 (DE) 10 2009 012 495.0

(51) Int. Cl. F16D 33/00

(52) U.S. Cl. 60/362

(57) ABSTRACT

The invention relates to a drivetrain, in particular a motor vehicle drivetrain, comprising: an engine; a gearbox comprising a main output and at least one auxiliary output; a hydrodynamic machine disposed at the auxiliary output on the gearbox output side; the hydrodynamic machine comprises a housing, stator vanes, and a rotor blade wheel; the rotor blade wheel can be driven by an input shaft; the input shaft is the output shaft of the auxiliary output or a shaft coaxially connected thereto. The drivetrain, in particular motor vehicle drivetrain, according to the invention is characterized by the following features: the housing of the hydrodynamic machine is designed in at least two parts, comprising a first housing part comprising the rotor blade wheel and the input shaft and mounted on the gearbox or integral to the same, a second housing part comprising the stator vanes and connection channels for feeding/discharging the working medium, wherein the second housing part is supported by the first housing part and is rotatably mounted on the first housing part or can be mounted on the first housing part at various rotated positions relative to the first housing part.

The invention relates to a drive train according to the preamble of claim 1 (cf. U.S. Pat. No. 5,829,562 A). The invention can be used especially in the drive train of a truck or bus.

It is currently common practice to equip trucks or busses for example with wear-free brakes, so-called retarders. Such retarders were conventionally oil retarders, which means retarders which were operated with hydraulic oil as a working medium. As a result of the heat produced during braking, this oil had to be guided through a separately provided heat exchanger in which the heat was transferred from the oil to the water cooling circuit of the vehicle for example. The heat was then emitted via the vehicle radiator to the ambient environment by means of the water cooling circuit of the vehicle, which contains water or a water mixture (water/glycol mixture), as is generally known.

Efforts have been made recently to use water retarders instead of oil retarders. Water retarders are understood to be retarders whose working medium is the cooling medium of the vehicle cooling circuit, therefore water or a water mixture. The advantage of this configuration is that an additional heat exchanger can be saved, thus reducing costs and necessary overall space. As a result, the position of the retarder in the drive train in the transmission on the output side of the transmission can be chosen more flexibly. When a bus is equipped with a conventional oil retarder for example, it is arranged on one side adjacent to the main power take-off, which means next to the transmission flange of the main power take-off, on an auxiliary power take-off. At the same time, the necessary heat exchanger had to be arranged on the opposite side of the transmission flange. This leads to the consequence that the oil retarder had to be arranged mostly on a specific side of the main power take-off. In contrast to this, more freedom in respect of positioning is provided by the arrangement of the retarder as a water retarder due to the omission of the heat exchanger. The retarder can be arranged at any side of the main power take-off.

This free arrangement has come with a considerable disadvantage up until now. It has been common practice to arrange the configuration of the retarder and especially the outside shape of the housing of the retarder depending on the desired positioning of the retarder on the output side of the transmission on a case to case basis. This leads to comparatively high development and production costs.

The invention is based on the object of providing a drive train with a hydrodynamic machine which is arranged on an auxiliary power take-off of a transmission which has been improved over the state of the art. In particular, a respective drive train is to be provided which is more cost-effective in development and production and overcomes the disadvantages as mentioned above.

The object in accordance with the invention is achieved by a drive train with the features of claim 1. The sub-claims describe especially advantageous further developments of the invention.

The arrangement of the invention with a two-part housing of the hydrodynamic machine allows high flexibility in the configuration of the machine itself because the second housing part can be attached with any desired axial twisting on the first housing part as long as the axis of the rotor blade wheel on the one side and the virtual axis of the stator blades on the other side correspond with one another. Moreover, this enables the first housing part as a standardized connecting element of the housing, comprising an input shaft and a rotor blade wheel with approximately randomly shaped housing parts which contain the stator blades. In this way, a simple and standardized connecting part of the hydrodynamic machine to the transmission can be created, with the hydrodynamic machine then being able be arranged in a variable fashion via the respective stator housing part. It is understood that it is also possible to provide various first housing parts which differ from the geometry of the associated rotor blade wheel for example in order to optionally combine one of these with a matching second housing part.

In an especially advantageous development of the invention, the second housing part is divided into a first section with the stator blades and a second section with the connections for the connecting conduits, with these sections being arranged to be twistable in relation to one another. In the region of the section boundaries, the connecting conduits are advantageously arranged at least as sections of circular rings. As a result, the section with the connecting conduits can be twisted in relation to the section with the stator blades without any further effort. As a result of the connecting conduits which are arranged in the form of circular sections, the twisting of the two sections against one another can be performed without interrupting the connecting conduits. The flexibility of the drive train as already mentioned above can thus be increased even further.

According to an advantageous development of the invention, the second housing part comprises a valve or several valves in order to control or adjust the flow of working medium into the hydrodynamic machine or the working chamber of the same, which is especially arranged in a toroidal manner, or from the hydrodynamic machine or the working chamber of the same. Additionally or alternatively, the second housing part can also comprise a control apparatus which controls or adjusts the flow of working medium into or out of the hydrodynamic machine or its working chamber, especially by means of the mentioned valves.

It is also provided in an especially advantageous development of the invention that the side of the housing of the hydrodynamic machine which faces the main power take-off has a concave bulging which is substantially parallel to the surface of the output shaft of the main power take-off.

Further advantageous developments of the invention arise from the remaining sub-claims and from the embodiment which will be explained below in closer detail by reference to the drawings, wherein:

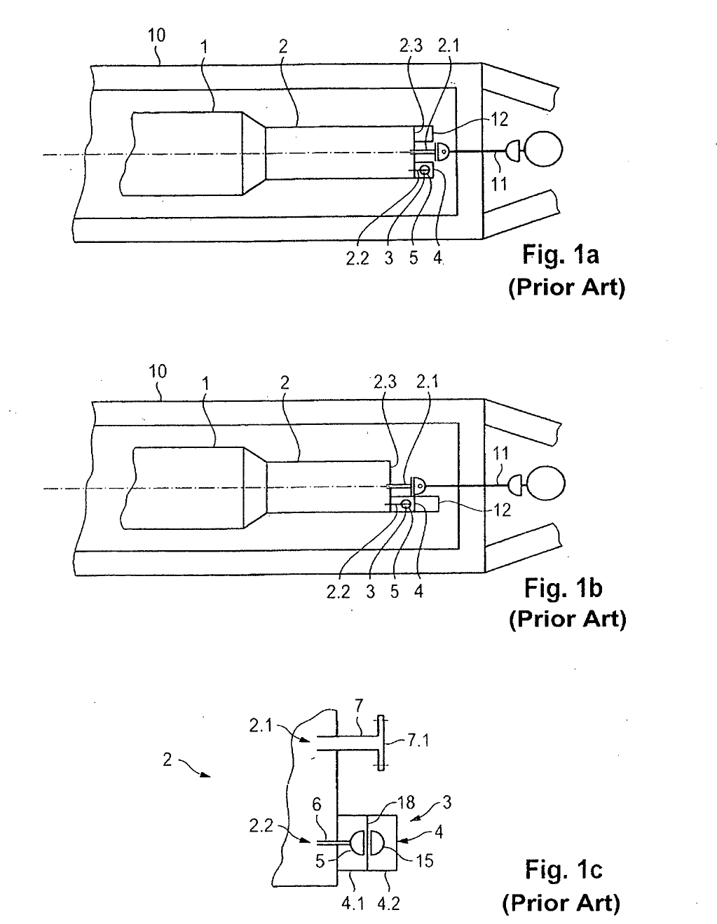

FIG. 1 shows a schematic illustration of a top view of two different drive trains with conventional oil retarders;

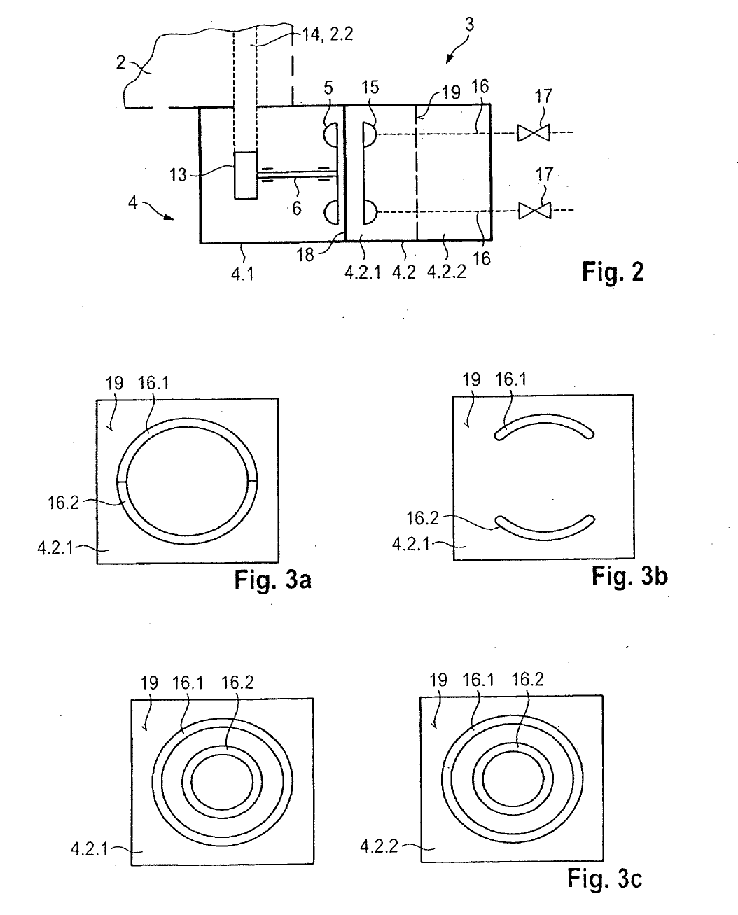

FIG. 2 shows the hydrodynamic machine in a detailed view;

FIG. 3 shows the connecting elements between the sections of the housing parts with the stator blades of the hydrodynamic machine, and

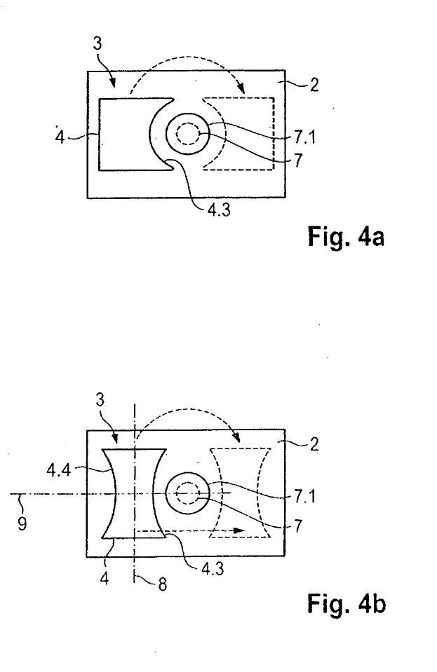

FIG. 4 shows an axial top view of the transmission output side of a drive train in accordance with the invention.

FIG. 1 shows the drive trains with an oil retarder in an exemplary way. FIG. 1a schematically shows the usual spatial conditions in a bus, whereas FIG. 1b shows the usual spatial conditions in a truck. FIG. 1c shows the detail again of the arrangement of retarder 3 of FIG. 1a in an enlarged view.

The illustrations show the frame 10 of the motor vehicle and engine 1 and the axially connected transmission 2. The transmission 2 comprises a transmission output side 2.3, on which the main power take-off 2.1 and an auxiliary power take-off 2.2 are shown. The main power take-off 2.1 drives the rear axle of the vehicle via a cardan shaft 11. For this purpose, an output shaft 7 with a connected transmission flange 7.1 is provided on the main power take-off 2.1. One retarder each is driven by means of the auxiliary drive 2.2. The retarder has a housing 4 and an input shaft 6 which drives the rotor blade wheel 5 of the retarder. The housing 4 is subdivided into a first housing part 4.1 and a second housing part 4.2, to which reference will be made further below in closer detail. All illustrations are purely schematic. The retarder will usually differ however in detail over the shown illustration.

The housing 4 of the retarder can be held exclusively on the housing of the transmission 2 for example. It is also possible to hold the rotor blade wheel 5 of the retarder in a floating manner, especially directly on the output shaft of the auxiliary power take-off 2.2. The rotor blade wheel 5 is alternatively held in the housing 4.

The input shaft 6, which drives the rotor blade wheel 5, can for example directly be the output shaft of the auxiliary power take-off 2.2 or also a separate shaft which is coupled especially coaxially with the output shaft of the auxiliary power take-off 2.2.

Due to the fact that the hydrodynamic machine 3 works with hydraulic oil as a working medium in the illustrated embodiment, a heat exchanger 12 is provided which is arranged as an oil/water heat exchanger. As a result of the short axial space of the illustrated drive train of a bus in FIG. 1, the heat exchanger 12 is arranged on the other side of the main power take-off 2.1, like the hydrodynamic machine 3. There is more axial space available in the truck as shown in FIG. 1b. That is why the heat exchanger 12 is arranged directly on the face side in the axial direction on the retarder or the hydrodynamic machine 3.

As can be seen, the necessary space which is required for the hydrodynamic machine 3 together with the heat exchanger 12 is relatively large. This narrows down the possibilities for positioning these components.

FIG. 2 shows the configuration which has already been indicated in the frame of FIG. 1c in a more detailed view, but it is modified concerning the bearing of the rotor blade wheel 5. In this case too, merely a principal illustration of the hydrodynamic machine 1 has been chosen. The housing 4 of the hydrodynamic machine 3 is subdivided into two housing parts 4.1 and 4.2. The first housing part 4.1 has the input shaft 6 and the rotor blade wheel 5 which is driven by this input shaft 6. Moreover, a gearwheel 13 is indicated by way of example which is in engagement with a gearwheel 14 of the transmission 2. The input shaft 6 and thus the rotor blade wheel 5 of the hydrodynamic machine 3 are driven respectively via this drive connection. The second housing part 4.2 of the housing 4 comprises the stator blade wheels 15 and the connecting lines 16 for the working medium for the retarder. Moreover, in the region of the housing 4, valve devices 17 can be arranged in the region of the connecting conduits 16 or on the housing 4.

This configuration allows arranging the second part 4.2 of the housing in a manner substantially independent of the first part 4.1 of housing 4 because it is merely necessary here to maintain the connecting area 18 and the concentricity of the stator blades 15 and the rotor blade wheel 5. Moreover, a type of standardized connecting part can be created with the housing part 4.1 which cooperates with the transmission 2 in a respective fashion. An approximately randomly arranged second housing part 2 can be placed on this connecting part 4.1, so that high flexibility is enabled concerning the arrangement and required space of the hydrodynamic machine 3. The connecting part 4.1 can thus be produced in a very cost-effective manner.

Since the connecting area 18 separates the working chamber of the retarder, a certain amount of flexibility can be achieved with respect to the exchange or the selection of the rotor blade wheel 5. The second housing part 4.2 can be adjusted to the respective geometry of the rotor blade wheel 5. In this way, different characteristics of the retarder can be achieved merely by suitable choice of the rotor blade wheel 5.1 and otherwise unchanged connecting part 4.1.

FIG. 2 shows an especially advantageous variant of the two-part housing 4 of the hydrodynamic machine 3, in which the second housing part 4.2 is subdivided again into two partial sections 4.2.1 and 4.2.2. The connection area 18 to the first housing part 4.1 and the stator blades 5 are integrated in the first partial section 4.2.1. The connecting elements such as the valve devices 17 for the connecting conduits 16 which are shown here by way of example are arranged in the second section 4.2.2 of the second housing part 4.2, or to the outside of the same. The two housing sections 4.2.1 and 4.2.2 can now be twisted against one another accordingly, so that the flexibility concerning the supply and discharge of the working medium and optionally the connection of further components such as the heat exchanger 12 or simple piping systems can be increased even further.

The FIGS. 3a to 3c show two embodiments for the arrangement of the connecting conduits in the region of the separating area 19 between the two partial sections 4.2.1 and 4.2.2 of the second housing part 4.2. FIG. 3a shows a first embodiment, in which the connecting conduits 16 in one of the two housing sections 4.2.1 are arranged as a circular conduit (in this case in form of a circular ring) which is subdivided into an inlet 16.1 and an outlet 16.2. The second housing section which is associated with the illustrated first housing section 4.2.1 (second housing section 4.2.2 in FIG. 2) can then comprise circular openings for forming connecting conduits 16 for example, with one opening each being associated with the inlet 16.1 and at least one opening each with the outlet 16.2. It is understood that other geometries are possible for the connecting conduits in the second housing section 4.2.2. As a result of the circular-ring-shaped cross sections of the inlet 16.1 and the outlet 16.2 in the first housing section 4.2.1, the associated sections of the connecting conduits 16 in the second housing section remain in suitable flow-conducting connection with the inlet 16.1 and the outlet 16.2 even in the case of twisting both housing sections 4.2.1 and 4.2.2 in relation to one another.

Instead of the cross sections of the inlet 16.1 and 16.2 which are shown in FIG. 3a and jointly form a full circular ring, it is also possible to chose such cross sections for the inlet 16.1 and the outlet 16.3 that they form only one sector each of a circumferential conduit (which in this case is in the shape of circular ring) without forming a full circular ring. Such an embodiment is shown in FIG. 3b. Other cross-sectional shapes of the connecting conduits 16 extending over the circumference in an axial cross section through the second housing part 4.2 are possible, both in the first partial section 4.2.1 and also in the second partial section 4.2.2 of the second housing part 4.2. It is sufficient when only one of the two partial sections 4.2.1 and 4.2.2 has connecting conduits 16 with a respective extension in the circumferential direction within the separating area 16.

FIG. 3c shows an alternative embodiment, in which the connecting conduits 16 are each arranged in the form of concentric circular rings in the region of the separating area 19. In the illustrated example, the outer ring is the inlet 16.1, whereas the inner ring is the return 16.2. A twisting of the two sections 4.2.1 and 4.2.2 against one another can occur here without any limitation of the angle of rotation.

In the further course of the embodiment, an arrangement of the housing 4 is described which can be realized both with a divided housing 4 in two parts 4.1, 4.2 and a second housing part 4.2 which is further subdivided into two partial sections 4.2.1 and 4.2.2.

FIG. 4 shows possibilities for further developments with respect to the housing 4 of the hydrodynamic machine 3. Two different embodiments in accordance with the invention are shown, which is an embodiment of housing 4 in FIG. 2a in which only the side 4.3 is arranged which faces the main power take-off 2.1 and is parallel to the surface of the output shaft 7. In FIG. 2b, the side 4.4 of housing 4 which is arranged opposite to the side 4.3 is arranged to be parallel in addition, which is conversely parallel to the surface of the output shaft 7.

The flexibility in the arrangement of the housing 4 of the hydrodynamic machine 3 arranged in accordance with the invention is illustrated by the dotted arrows. As a result, the same hydrodynamic machine, which means a hydrodynamic machine 3 with an identical or substantially identical housing, can be arranged in FIG. 4a on the other side of the main power take-off 2.1. This occurs fictitiously simply by turning the hydrodynamic machine by 180 degrees about the longitudinal axis of the output shaft 7 of the main power take-off train. It is understood that rotations about other degrees are possible, e.g. rotations about 90 degrees, so that the hydrodynamic machine 3 is arranged above the main power take-off 2.1.

In FIG. 4b, the possible further position of the hydrodynamic machine 3 which is shown with the broken line can be achieved on the one hand by rotation and also by displacement, as is again shown by the dotted arrows. The displacement offers the advantage that the upper side of the hydrodynamic machine 3 is also aligned upwardly in the illustrated alternative position, which can be relevant in the positioning of connections such as the hydrodynamic retarder. When the hydrodynamic machine is a water retarder for example, the connections for the connection to the cooling circuit of the vehicle must be provided.

In the illustrated embodiments, the entire surfaces 4.3 and the surfaces 4.4 are arranged coplanar to the surface of the output shaft 7 of the main power take-off 2.1. It is sufficient within the terms of the invention when merely one inwardly bulging recess, which means a concave bulging, is provided on the respective side 4.3, 4.4 of the housing 4.

Furthermore, the mentioned pages 4.3, 4.4 and the bulging portions in these sides need not be arranged completely parallel to the surface of the output shaft 7. A substantial parallel correspondence will usually be sufficient. “Substantially parallel” shall be understood that the parallelism is sufficient in order to arrange the hydrodynamic machine very close to the output shaft 7 of the main power take-off 2.1.

The parallelism of the respective side 4.3, 4.4 of the housing 4 of the hydrodynamic machine 3 generally means that there is also parallelism with the transmission power take-off flange 7.1, which differs from the shaft 7 only in respect of a larger outside diameter. It is thus also possible to arrange the respective sides 4.3, 4.4 parallel to the outside circumference of the transmission power take-off flange 7.1 in accordance with the invention.

### LIST OF REFERENCE NUMERALS

1 Engine
2 Transmission
2.1 Main power take-off
2.2 Auxiliary power take-off
2.3 Transmission power take-off side
3 Hydrodynamic machine
4 Housing
4.1, 4.2 Housing parts
4.2.1, 4.2.2 Sections of the housing parts 4.2
4.3, 4.4 Side or surface of housing
5 Rotor blade wheel
6 Input shaft
7 Output shaft
7.1 Transmission power take-off flange
8 Perpendicular
9 Horizontal
10 Frame
11 Cardan shaft
12 Heat exchanger
13, 14 Gearwheels
15 Stator blades
16 Connecting conduits
16.1 Inlet
16.2 Outlet
17 Valve devices
18 Connecting area
19 Separating area

1-11. (canceled)

12. A drive train, especially a drive train for a motor vehicle, comprising:
an engine;
transmission which comprises a main power take-off and at least one auxiliary power take-off;
a hydrodynamic machine which is arranged on the auxiliary power take-off on the power take-off side of the transmission;
the hydrodynamic machine comprises a housing, stator blades and a rotor blade wheel;
the rotor blade wheel can be driven via an input shaft;
the input shaft is an output shaft of auxiliary power take-off or a shaft which is coaxially connected with the same;
characterized by the following features:
the housing of the hydrodynamic machine is arranged at least in two parts, comprising
a first housing part which comprises the rotor blade wheel and the input shaft and is mounted on the transmission or is arranged integrally with the same;
a second housing part which comprises the stator blades and the connecting conduits for the supply of the working medium to hydrodynamic machine and the discharge therefrom, with
the second housing part being carried by the first housing part and being mounted in a twistable manner on the first housing part or being mountable on the first housing part in different twisting positions in relation to the first housing part.

13. A drive train according to claim 12, characterized in that the second housing part is subdivided into a first section with the stator blades and a second section with the connecting conduits, with the sections being mounted to be twistable in relation to one another or being arranged to be mountable in different twisting positions in relation to one another, and with the connecting conduits being arranged at least as partial sections of a circumferential conduit, especially a circular ring, especially at least in the region of the separating area between the first section and the second section.

14. A drive train according to claim 13, characterized in that the connecting conduits are arranged in the region of the separating area as concentric circular conduits, especially concentric circular rings.

15. A drive train according to claim 12, characterized in that the subdivision of the housing into its housing parts is arranged in such a way that the connecting area between the housing parts extends through the working chamber of the hydrodynamic machine.

16. A drive train according to claim 13, characterized in that the subdivision of the housing into its housing parts is arranged in such a way that the connecting area between the housing parts extends through the working chamber of the hydrodynamic machine.

17. A drive train according to claim 14, characterized in that the subdivision of the housing into its housing parts is arranged in such a way that the connecting area between the housing parts extends through the working chamber of the hydrodynamic machine.

18. A drive train according to claim 12, characterized in that the side of the housing at least of the first housing part of the hydrodynamic machine, which side faces the main power take-off, has a concave bulging which is substantially parallel to the surface of an output shaft of the main power take-off.

19. A drive train according to claim 13, characterized in that the side of the housing at least of the first housing part of the hydrodynamic machine, which side faces the main power take-off, has a concave bulging which is substantially parallel to the surface of an output shaft of the main power take-off.

20. A drive train according to claim 14, characterized in that the side of the housing at least of the first housing part of the hydrodynamic machine, which side faces the main power take-off, has a concave bulging which is substantially parallel to the surface of an output shaft of the main power take-off.

21. A drive train according to claim 18, characterized in that further the side of the housing which is arranged to be opposite of the side facing the main power take-off comprises a concave bulging which in a mirrored manner is substantially parallel to the surface of the output shaft of the main power take-off and/or is arranged to be mirror-inverted in relation to the side (4.3) facing the main power take-off.

22. A drive train according to claim 18, characterized in that the entire side of the housing of the hydrodynamic machine which faces the main power take-off is arranged to be substantially parallel to the output shaft of the main power take-off and especially further the entire side of the housing which is arranged opposite of the side facing the main power take-off is arranged to be substantially parallel in a mirror-inverted manner relative to the surface of the output shaft of the main power take-off.

23. A drive train according to claim 12, characterized in that the hydrodynamic machine is a retarder, especially a water retarder.

24. A drive train according to claim 12, characterized in that the rotor blade wheel of the hydrodynamic machine is held in a floating manner on the output shaft of the auxiliary power take-off.

25. A drive train according to claim 12, characterized in that the housing, at least the first housing part, of the hydrodynamic machine is provided in mirror symmetry above a perpendicular through the central point of the housing, when viewed in the direction of the rotational axis.

26. A drive train according to claim 12, characterized in that the housing, at least the first housing part, of the hydrodynamic machine is provided in mirror symmetry above a horizontal line through the central point of the housing, when viewed in the direction of the rotational axis.
